(19) United States
(12) Patent Application Publication
(10) Pub. No.: US 2004/0173031 A1
(43) Pub. Date: Sep. 9, 2004

(54) Mass flow measurement

(76) Inventors: Shlomo Gicza, Willowdale (CA); Bruno Pross, Pazzallo (CH)

Correspondence Address: Dowell & Dowell, P.C., Suite 309, 1215 Jefferson Davis Hwy., Arlington, VA, 22202-3124, US

(21) Appl. No.: 10/379,808

(22) Filed: Mar. 6, 2003

(51) Int. Cl. G01F 1/78

(52) U.S. Cl. 73/861.351

(57) ABSTRACT

A method of measuring mass flow of a material comprising the steps of passing said material across a platform driven by a vibratory drive, oscillating the platform by the drive to obtain a predetermined amplitude of oscillation, at resonance, measuring the frequency of the oscillation and correlating the frequency to a mass flow rate.

### BACKGROUND OF THE INVENTION

The present invention relates to mass flow measurement.

### FIELD OF THE INVENTION

The determination of mass flow rate is desirable in many processes. However where the process is continuous, the mass flow rate is difficult to determine without interrupting the process to effect a measurement in unit time. Prior proposals to measure mass flow have included load cells to determine the dynamic loads placed on a surface by moving material or motion transponders that determine the velocity of movement of a material and approximate the mass flow rate. Such devices are however relatively complex and their calibration is difficult.

Most of these prior attempts have been incorporated with a conveying device used to transport the materials between locations. A particularly beneficial form of conveyer used in material handling is a vibratory conveyor that induces an oscillatory motion onto a portion of the conveyor and induces material to flow along the conveyor. A particularly beneficial form of vibrator conveyor is that sold by Arbo Engineering Inc. The vibratory conveyor is magnetically driven and may be tuned such that the driven frequency equates to the natural or resonant frequency of the conveyor plus the material to be conveyed.

While such magnetic oscillatory drives have found widespread use in conveying, there is still a requirement to monitor mass flow through such conveyors in order to adjust other process perimeters. Prior proposals with such conveyors have utilised sensitive scales and whilst these have found widespread use they have not lent themselves to integrated process controls.

It is therefore an object to the present invention to obviate or mitigate the above disadvantages.

In general terms the applicants have recognized that by measuring changes in the resonant frequency at a predetermined amplitude, changes in mass flow across the vibratory conveyor can be obtained.

### SUMMARY OF THE INVENTION

In general terms, the present invention provides a method and apparatus in which changes in the frequency of oscillation at a predetermined amplitude may be correlated to mass flow. More specifically, according to the present invention there is provided a method of measuring mass flow of a material conveying the steps of passing said material across a conveyor driven by a vibratory drive, oscillating said platform by said drive at a resonant frequency to obtain a predetermined amplitude of oscillation, measuring the frequency of said oscillation and correlating said frequency to a mass flow rate.

### BRIEF DESCRIPTION OF THE DRAWINGS

These and other features of the preferred embodiments of the invention will become more apparent in the following detailed description in which reference is made to the appended drawings wherein:

FIG. 1 is a schematic representation of a magnetic vibratory drive utilized in a process control environment.

FIG. 2 is a schematic circuit diagram showing the operation of the drive in FIG. 1.

FIG. 3 is a schematic representation showing the utilization of the drive in FIG. 1 in a further process control environment.

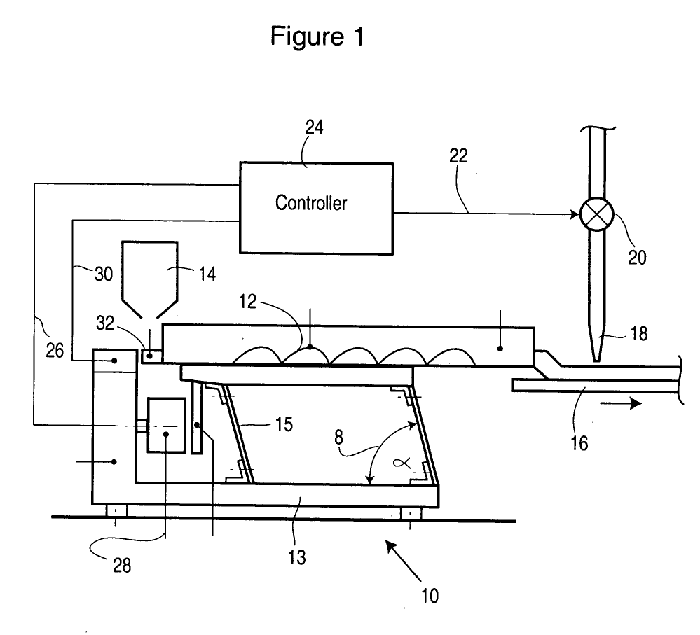

Referring therefore to FIG. 1, a vibratory conveyor 10 is utilized to transport a granular material indicated at 12 from an inlet 14 to an outlet conveyor 16. For the purposes of illustration and by way of example only the granular material 12 is shown as having a coating applied through a funnel 18 with the flow rate controlled by a valve 20. The position of the valve and therefore the flow rate through the nozzle 18 is adjusted by the application of a control signal 22 derived from a controller 24 to a valve actuator 25. The conveyor 10 includes a tray 11 supported on a base 13 by a pair of blade springs 15. The tray 11 may thus oscillate under the control of a drive 17.

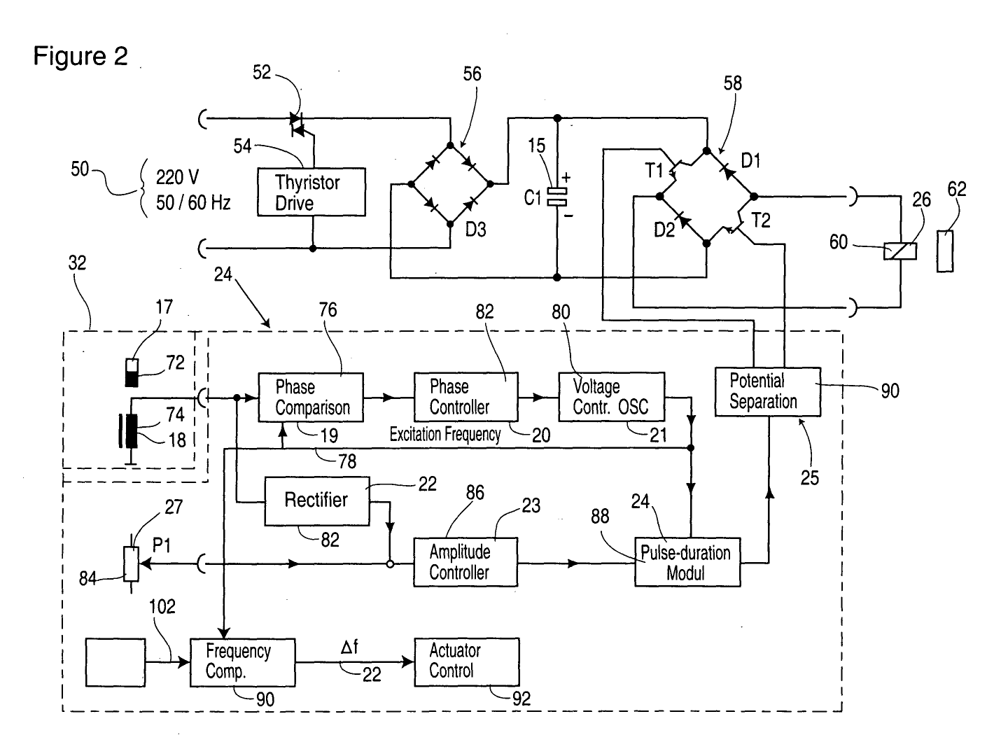

The controller 24 provides a drive signal 26 to an electromagnetic drive 17 and receives a control signal 30 from a sensor assembly 32. The operation of the controller can be seen in more detail in FIG. 2. Power is supplied from a source 50 through a TRIAC 52 and a thyristor drive 54 to a rectifier 56. The dc outlet from the rectifier 56 is applied through a power bridge circuit 58 to a drive coil 60 forming part of the electromagnetic drive 17. The coil 60 acts upon the armature of 62 to induce movement of the platform 11 relative to the base 13 by flexure of the springs 15.

The output of the power bridge circuit 58 is switched by control of the transistors T1 T2 in the bridge circuit 58. The biasing current for the transistors T1 T2 is obtained from the controller 24 and sensor 32. The sensor 32 includes a magnet 72 secured to the tray 11 and a pick up coil 74 mounted to the base 13. A displacement signal is generated by the coil 74 and fed to a phase comparator 76. The phase comparator 76 also receives an input signal 78 from the output of a voltage controlled oscillator 80 whose output is adjusted by a phase controller 82 connected between the phase comparator 76 and the voltage controlled oscillator 80. The phase controller 82 receives the output from the phase comparator which is indicative of the difference between the excitation frequency and the sensed signal and provides an adjustment signal to the voltage oscillator 80 to reduce the difference to a minimum.

The output from the coil 74 of sensor 32 is also rectified by a rectifier 82 so as to be indicative of amplitude of displacement and is combined with a set signal obtained from an amplitude setting control 84. The amplitude setting control 84 provides a signal indicative of a predetermined amplitude, typically the maximum amplitude to be obtained from the drive and the difference between the rectified signal and the reference signal is provided to an amplitude controller 86 which in turn produces an output indicative of the difference between the measured and desired amplitude. The output of the amplitude controller 86 is applied to a pulse duration modulator 88 which applies a switching current through the circuit divider 90 to determine the periods in which the transistors T₁, T₂ are conducting. The drive 28 is thus driven at a frequency and duration to maintain the amplitude at the predetermined amplitude.

The output from the voltage controlled oscillator 80 is also applied to a frequency comparator 90 that receives a reference signal 92 indicative of resonant frequency under controlled conditions, typically, no load. The frequency comparator 90 provides an output indicative of the difference between the reference signal 102 and the frequency of oscillation to provide a control signal 22 proportional to the differential frequency. The control signal 22 is applied to the actuator 25 associated with the valve 20.

In operation, initially, the device 10 is operated with no mass on the platform 11 and the required amplitude set in the set point 84. The resonant frequency of oscillation is also determined at this amplitude and provided as a reference signal 102. Typically, the amplitude is set to a maximum value and resonant frequency measured. A second reference signal may also be obtained by operating the conveyor 10 at a known mass flow rate and determining the resonant frequency at which the predetermined amplitude is obtained. The second reference point then provides a scaling factor to permit the effect of the error signal 22 to be calibrated for the valve 20.

After initialisation, material is deposited from the supply 14 on to the tray 11 and discharged on to the conveyor 16. The drive 28 adjusts the control to the coil 60 to produce the amplitude as determined by the set point 84 and the frequency of the oscillation is determined by the output of the voltage controlled oscillator 80. Because of the mass of material on the platform 12, the resonant frequency of the drive changes and is detected as a difference from the reference signal 90. The difference is produced as the error signal 22 to adjust the valve 20 and allow the coating to flow through the nozzle 18 onto the material 12.

If the mass flow rate through the conveyor increases, the mass contained on the platform 11 will similarly increase and the resonant frequency of oscillation will likewise decrease. The drive maintains the amplitude at the set level at the “new” resonant frequency. An increased difference signal is provided by the frequency comparator 90 which is applied to the actuator control 25 to increase the flow rate of coating through the nozzle 18. The valve 20 is thus controlled in proportion to the changes in mass flow rate to apply the appropriate coating in an appropriate proportion. Similarly a decrease in the mass flow rate will cause a reduction in the coating in proportion to the sensed decrease in the mass flow rate.

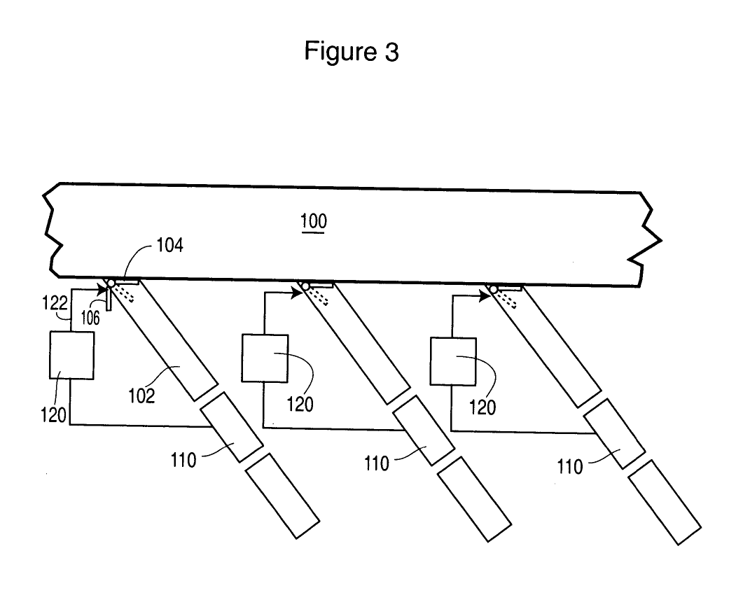

In the example given in FIG. 1, the error signal 22 is utilized to control a flow supplementary to that handled by the conveyor 10. In an alternative embodiment as shown schematically in FIG. 3, the signal 22 is utilized to control the mass flow across the conveyor 12 and maintain it at a predetermined level.

In the arrangement shown in FIG. 3, a main conveyor 100 supplies material to branch conveyors 102. Flow to the branch conveyors is controlled by a gate 104 whose position can be adjusted through an actuator 106. Each of the branch conveyors 102 includes a oscillatory conveyor 110 having a controller 120 to provide a control signal 122 to the actuator 106. The controller 120 monitors the resonant frequency of oscillation of the conveyor 110 and provides the error signal 122 to the actuator to maintain the flow rate across conveyor 110 at a predetermined level. If the mass flow rate decreases from the set level, the signal 122 is adjusted to open the gate 104 and increase the mass flow rate and, conversely, if the mass flow rate decreases, the gate 104 is closed.

In this manner, multiple branch conduits as indicated in FIG. 3 can be adjusted to maintain the mass flow rate substantially the same, which may be useful in, for example, packaging machines where multiple stations need to be supplied with identical flow rates.

Although the invention has been described with reference to certain specific embodiments, various modifications thereof will be apparent to those skilled in the art without departing from the spirit and scope of the invention as outlined in the claims appended hereto.

The embodiments of the invention in which an exclusive property or privilege is claimed are defined as follows:

1. A method of measuring mass flow of a material comprising the steps of passing said material across a platform driven by a vibratory drive, oscillating said platform at a resonant frequency by said drive to obtain a predetermined amplitude of oscillation, measuring the frequency of said oscillation and correlating said frequency to a mass flow rate.

2. A method according to claim 1 wherein said conveyor is operated in a first predetermined condition to obtain a reference frequency and changes from said reference frequency is correlated to change in a mass flow rate.

3. A method according to claim 2 wherein said first predetermined condition is without any mass on said conveyor.

4. A method according to claim 2 wherein said conveyor is operated at a second predetermined condition to obtain a second reference frequency and changes in frequency are correlated to change in mass flow determined between said reference frequencies.

5. A method of controlling a variable parameter in accordance with variations in a mass flow of a material comprising the steps of passing said material across a conveyor driven by a vibratory drive, driving said drive at a predetermined amplitude of oscillation at a resonant frequency, determining changes in the frequency of said oscillation and adjusting said parameter in accordance with said changes in frequencies.

6. A method according to claim 5 wherein said parameter is used to control the mass flow across said conveyor.

7. A conveyor comprising a platform, a support to permit oscillatory motion of said platform relative to a base, an electromagnetic vibratory drive acting upon said platform to induce oscillation thereof, a control to maintain oscillation of said platform predetermined amplitude of oscillation, and a detector to measure the frequency of said oscillation and provide an output signal indicative of changes of said frequency from a reference frequency.

8. A conveyor according to claim 7 wherein said detector acts between said platform and said support to monitor oscillatory movement.

9. A conveyor according to claim 8 wherein said detector includes an inductive coupling to monitor displacement of said platform.

10. A conveyor according to claim 9 wherein said coupling includes a coil secured to said support and a magnet secured to said platform.
